(19) United States
(12) Patent Application Publication
(10) Pub. No.: US 2002/0126656 A1
(43) Pub. Date: Sep. 12, 2002

(54) Method of providing packet voice call service in wireless communication network and network architecture therefor

(75) Inventor: Do-Jun Park, Seoul (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/028,494

(22) Filed: Dec. 20, 2001

(30) Foreign Application Priority Data
Mar. 10, 2001 (KR) 12459/2001

(51) Int. Cl. H04L 12/66

(52) U.S. Cl. 370/352; 370/401

(57) ABSTRACT

There is provided a method of providing a voice call service and an additional service to a circuit network terminal via a packet-based network, and a network architecture therefor. In the network architecture, a RAN provides a call service to the circuit network terminal, a mediation gateway makes the circuit network terminal recognized as a packet network terminal in the packet-based network by performing IP registration for the circuit network terminal. An access gateway provides predetermined traffic interfacing upon request from the mediation gateway and transmits voice traffic from the circuit network terminal to a terminal of a called party via the packet-based network.

### PRIORITY

This application claims priority to an application entitled “Method of Providing Packet Voice Call Service in Wireless Communication Network and Network Architecture Therefor” filed in the Korean Industrial Property Office on Mar. 10, 2001 and assigned Ser. No. 2001-12459, the contents of which are hereby incorporated by reference.

### BACKGROUND OF THE INVENTION

1. Field of the Invention

The present invention relates generally to a wireless communication network, and in particular, to a method of providing a voice call service and an additional service over an IP (Internet Protocol) core network to a terminal supporting a circuit-based network in an IMT-2000 system, and the structure of the network.

2. Description of the Related Art

IMT-2000 (International Mobile Telecommunications-2000) is known as the future synchronous or asynchronous mobile telecommunication system that enables a single terminal to use communication services all over the world based on globally unified standards for diverse mobile telecommunication systems (i.e., legacy systems) individually deployed in different nations. IMT-2000 is characterized by connectivity to multiple services with a single terminal. For example, a user can be in video conference while accessing graphics over the Internet/Intranet, exchanging multimedia mails, and transmitting lots of data files at the same time. IMT-2000 also provides global roaming, wireless video services, remote video conferencing, and bi-directional entertainment.

Specifically, synchronous IMT-2000 defines detailed standards about radio access network (RAN) matching, the structure of a core network, wireless packet data networking, and terminals. This IMT-2000 system basically employs an all IP (Internet Protocol) core network structure to provide packet-based voice and data call services to a terminal that can be assigned an IP address from a packet-based network. Therefore, there is a need for constructing a separate core network to provide a voice call service to a typical circuit-based terminal.

FIG. 1 is a schematic view of a typical synchronous IMT-2000 all IP core network. A solid line denotes the flow of voice traffic and data traffic and a dotted line denotes the flow of control signals.

Referring to FIG. 1, a RAN 110, as is well known in the art, is comprised of a plurality of BTSs (Base Transceiver Subsystems) 112, a plurality of BSCs (Base Station Controllers) 114, and an MM (Mobility Manager) 116. The RAN 110 can connect radio channels to a terminal 15 supporting a circuit-based network (hereinafter, referred to a circuit network terminal) as well as a terminal 10 supporting a packet-based network (hereinafter, referred to as a packet network terminal).

The packet network terminal 10 registers a mobile IP address in an SCM (Session Control Manager) 150 and an HA (Home Agent) 180 and is connected to another subscriber system under the control of the SCM 150. When the packet network terminal 10 requests a packet call service, an AG (Access Gateway) 140 checks a gateway connected to the packet network terminal of the other party, for example, a media gateway (MG) 170 and then initializes a session. Then the AG 140 exchanges traffic packets with the MG 170 by IP communication.

The above synchronous IMT-2000 all IP core network, including a packet network and a packet network terminal provides VoIP (Voice Over IP) and IP data services.

Meanwhile, the circuit network terminal 15 is connected to another subscriber system under the control of a circuit network MS domain 130. The circuit network MS domain 130 includes an MSC (Mobile Switching Center) server 132 for connecting calls to circuit network terminals and controlling the call connections using subscriber information and an HLR (Home Location Register) 134 for providing the subscriber information to the MSC server 132. The MSC server 132 accesses the subscriber database of the HLR 134 via an IS-41 interface like a typical MSC, but just processes control signaling for connecting the circuit network terminal 15 to another subscriber system over the RAN 110 without switching traffic.

There will be given a detailed description of a conventional voice call connection to a circuit network terminal.

When the circuit network terminal 15 requests a call setup to the MSC server 132 via the RAN 110, the MSC server 132 performs a known operation including subscriber authorization by communicating with the HLR 134 via the IS-41 interface and commands the BTS 112 of the RAN 110 to assign a radio traffic channel to the circuit network terminal 15. Then, the MSC server 132 checks a called terminal and requests the gateway connected to the called terminal, for example, the MG 170 to communicate with the RAN 110. The MG 170 establishes a call connection path directly with the RAN. The circuit network terminal 15 conducts a voice call with the called terminal in the established call connection path.

The above basic network model for the synchronous IMT-2000 system provides just a conventional MSC-based voice call service to a circuit network terminal using a separate network device, i.e., a circuit network terminal supporter, not a voice call service to the circuit network terminal by IP communication. That is, the synchronous IMT-2000 all IP network model does not accommodate IP service features for the existing IS-41 circuit-based terminals.

In this case, the overall network must include two core networks (a packet-based network and a circuit-based network) to support two different services, thereby incurring much network overhead. Furthermore, the network cannot provide an integrated service covering new IP subscribers and existing legacy subscribers. This implies that diverse call services, for example, an interactive call service cannot be provided to a circuit network terminal over an IP network. Moreover, the MSC server is required to perform authorization, assign a radio traffic channel and then establish a call connection path between the RAN and the MG in order to provide a voice call service to the circuit network terminal. As a result, a call connection delay is generated.

### SUMMARY OF THE INVENTION

It is, therefore, an object of the present invention to provide a method of supporting a voice call service to a circuit network terminal by IP communication over a packet-based data core network by interposing a gateway network device between a circuit-based network and the packet-based network.

It is another object of the present invention to provide a network architecture for supporting a voice call service to a circuit network terminal by IP communication over a packet-based data core network by interposing a gateway network device between a circuit-based network and the packet-based network.

It is yet another object of the present invention to provide a method of supporting a VoIP service and an additional IP service to a circuit network terminal over a data core network in an all IP network.

It is still another object of the present invention to provide a network architecture for supporting a VoIP service and an additional IP service to a circuit network terminal over a data core network in an all IP network.

The above and other objects of the present invention are achieved by providing a method and a network architecture for providing a packet voice call over a packet-based network to a circuit network terminal supporting wireless communication over a circuit-based network.

According to one aspect of the present invention, in the network architecture, a RAN provides a call service to a circuit network terminal. A mediation gateway is connected to the RAN via a predetermined signaling interface of the circuit-based network. The mediation gateway performs location registration, authorization, and mobility management to provide a packet voice call service to the circuit network terminal and makes the circuit network terminal recognized as a packet network terminal in the packet-based network by performing IP registration for the circuit network terminal. An access gateway is connected to the mediation gateway via a predetermined signaling interface and provides predetermined traffic interfacing upon request from the mediation gateway. The access gateway is also connected to the RAN and transmits voice traffic from the circuit network terminal to a terminal of the other party via the packet-based network.

According to another aspect of the present invention, in a registration method for providing a packet voice call service over a packet-based network to a circuit network terminal supporting wireless communication over a circuit-based network, a registration request is received from the circuit network terminal through a RAN via a circuit-based network interface. The subscriber information of the circuit network terminal is updated and the location of the circuit network terminal is registered. The IP registration of the circuit network terminal is requested to the packet-based network. A registration result is transmitted to the circuit network terminal via the RAN upon receipt of the registration result from the packet-based network.

According to a further aspect of the present invention, in a call origination method for providing a packet voice call service over a packet-based network to a circuit network terminal supporting wireless communication over a circuit-based network, a mediation gateway receives a packet voice call origination request from the circuit network terminal through a RAN via a circuit-based network interface and transmits IP protocol information generated for the circuit network terminal to an access gateway. The access gateway connects the circuit network terminal to the packet-based network using the IP protocol information and provides the packet voice call service to the circuit network terminal.

According to still another aspect of the present invention, in a call termination method for providing a packet voice call service over a packet-based network to a circuit network terminal supporting wireless communication over a circuit-based network, the packet-based network requests a call termination at the circuit network terminal to a mediation gateway. The mediation gateway pages the circuit network terminal through a RAN via a circuit-based network interface and transmits IP protocol information generated for the circuit network terminal to an access gateway upon receipt of a response for the paging. Then, the access gateway connects the circuit network terminal to the packet-based network using the IP protocol information and provides the packet voice call service to the circuit network terminal.

### BRIEF DESCRIPTION OF THE DRAWINGS

The above and other objects, features and advantages of the present invention will become more apparent from the following detailed description when taken in conjunction with the accompanying drawings in which:

FIG. 1 is a schematic diagram of a typical synchronous IMT-2000 all IP core network;

FIG. 2 is a schematic diagram of a synchronous IMT-2000 all IP core network including a mediation gateway according to the present invention;

FIG. 3 illustrates a network architecture for providing a voice packet service to a circuit network terminal according to the present invention;

FIG. 4 is a block diagram of the mediation gateway shown in FIG. 3 according to the present invention;

FIG. 5 is a block diagram of a packet network supporter shown in FIG. 4 according to the present invention;

FIG. 6 is a block diagram of an AG (Access Gateway) shown in FIG. 3 according to the present invention;

FIG. 7 is a block diagram of an IP bearer shown in FIG. 6 according to the present invention;

FIG. 8 is a view showing a signal flow for packet voice call origination in a circuit network terminal according to the present invention; and

FIG. 9 is a view showing a signal flow for packet voice call termination in the circuit network terminal according to the present invention.

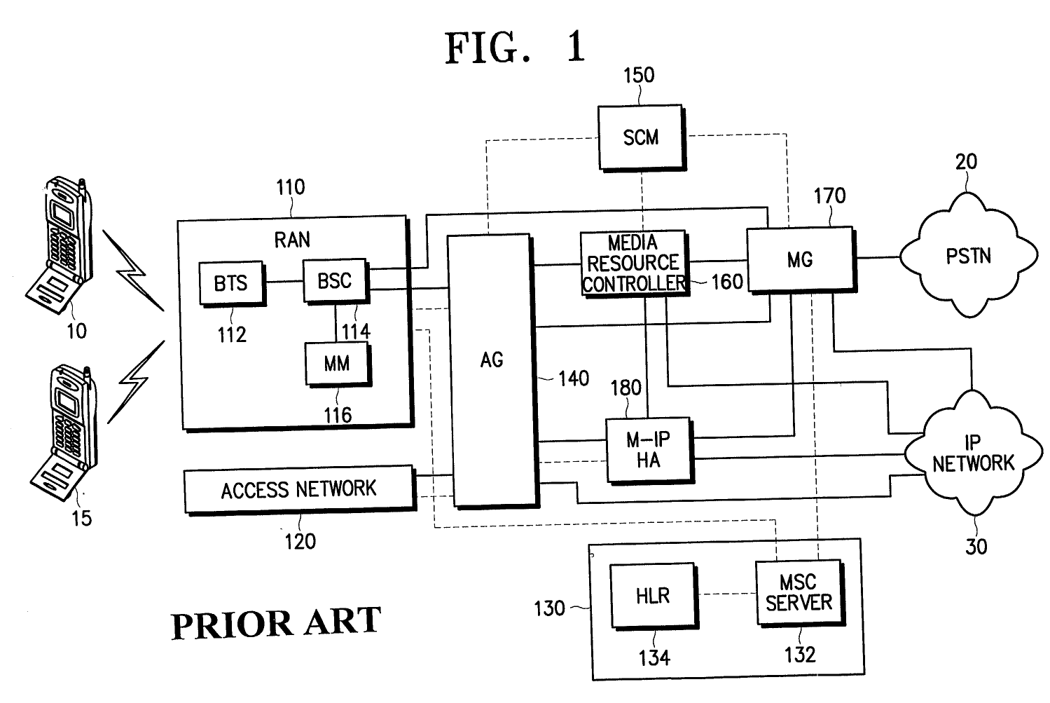

### DETAILED DESCRIPTION OF THE PREFERRED EMBODIMENT

A preferred embodiment of the present invention will be described hereinbelow with reference to the accompanying drawings. In the following description, well-known functions or constructions are not described in detail since they would obscure the invention in unnecessary detail.

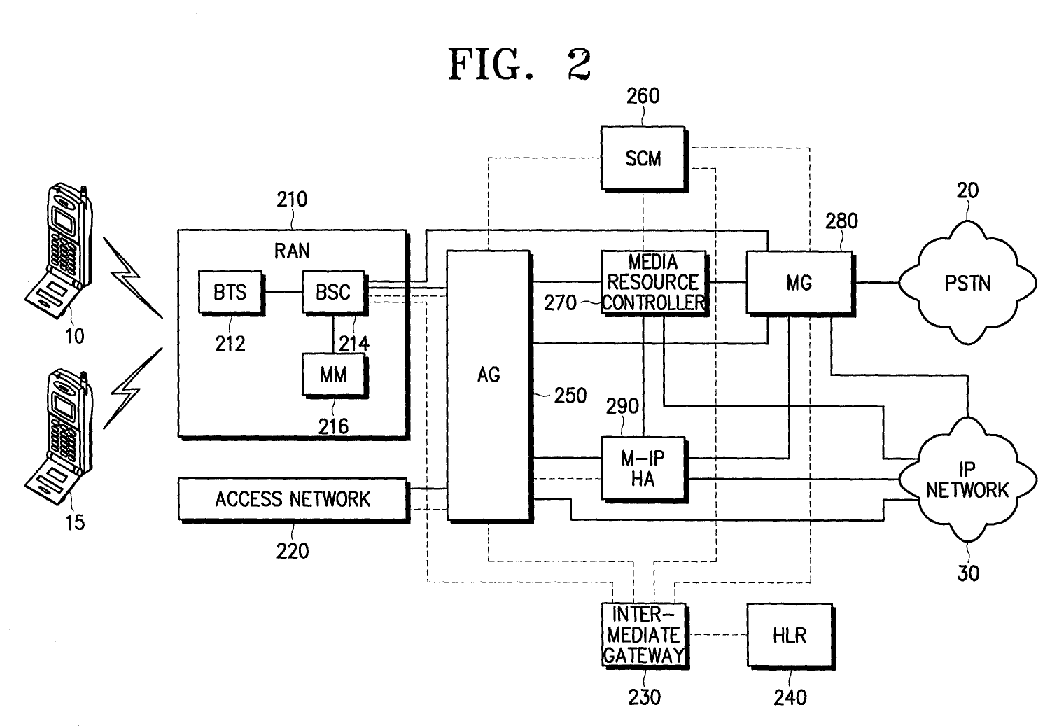

FIG. 2 is a block diagram of an all IP core network including a mediation gateway according to the present invention. It is to be noted here that a solid line denotes the flow of voice and data traffic and a dotted line denotes the flow of control signals. In the following description, a terminal connectable to a typical circuit-based network is called a circuit network terminal and a terminal connectable to a packet-based network is called a packet network terminal. For example, a circuit network terminal can be a legacy terminal supporting the first-or second-generation CDMA communication and a packet network terminal can be an IP terminal that is capable of conducting packet communications in TCP/IP (Transmission Control Protocol/Internet Protocol), being assigned to a mobile IP address. Additionally, a packet network terminal can be capable of conducting packet communications in UDP (User Datagram Protocol).

Referring to FIG. 2, the all IP core network according to the present invention includes a mediation gateway 230 for signaling the circuit network terminal 15 in addition to the network devices of the basic all IP core network structure. The network devices are an HA 290 for assigning mobile IP addresses to a packet network terminal and a circuit network terminal, an AG 250 for connecting a RAN 210 to a packet network, an SCM 260 for VoIP service, an MG 280 for connecting to the PSTN (Public Switched Telephone Network) or to another network, at least one AAA (Authorization, Authorization, and Accounting computer) server (not shown), and a DNS (Domain Name Server) (not shown) for managing IP addresses and domain names corresponding to the IP addresses. The RAN 210 includes a BTS 212 for accessing radio channels, a BSC 214, and an MM 216 for registering the location of a terminal within the RAN 210. The BSC 214 includes a BAN (BSC ATM Node) interfacing with the BTS 212 and an ATP (Air Termination Processor) for connecting traffic-related signals to the AG 250.

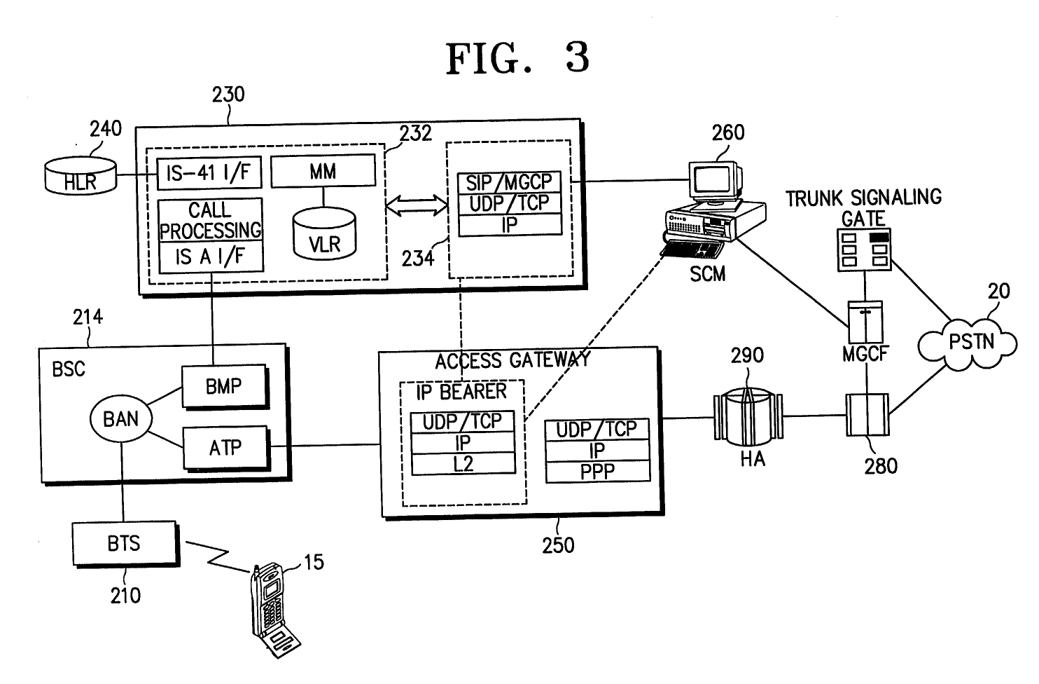

FIG. 3 illustrates the configuration of a network for providing a voice packet service to a circuit network terminal according to the present invention.

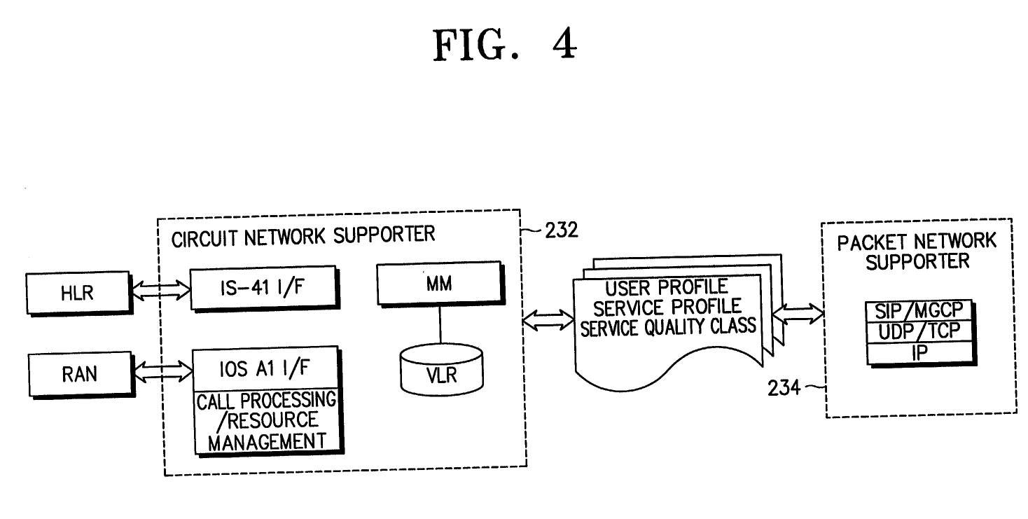

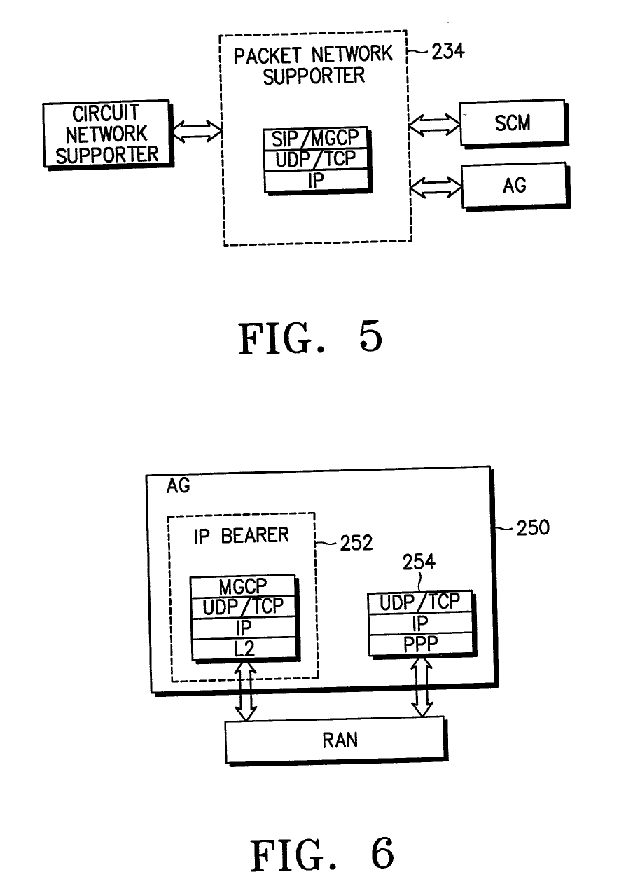

Referring to FIG. 3, the mediation gateway 230 converts or translates IS-41 interface signals to IP signals and provides a voice call service for a circuit network terminal along with other adjacent network devices. The main function of the mediation gateway 230 is illustrated in FIG. 4. In FIG. 4, the mediation gateway 230 is largely divided into a circuit network supporter 232 and a packet network supporter 234. The main function of the packet network supporter 234 is illustrated in detail in FIG. 5.

Referring to FIG. 4, the circuit network supporter 232 supports an IOS-Al interface for interworking with the RAN 210, an IS-41 interface for interworking with an HLR of an IS-41 network, and mobility management for paging, handoff, and location registration over a circuit network. Particularly for IOS A1 interfacing, an SS7 (Signaling System No. 7) or ATM (Asynchronous Transfer Mode) is used for connection to a circuit-based BSC, or an IP interface is used for adaptability to the all IP network structure.

Referring to FIG. 5, the packet network supporter 234 supports SIP (Session Initiation Protocol) for interfacing with the SCM 260, IP, and MGCP (Media Gateway Control Protocol) for interfacing with the AG 250. Since the AG 250 and the mediation gateway 230 function as the MG and an MG control function block (MGCF), interfacing between the packet network supporter 234 and the AG 250 is basically the same as the MGCP interfacing between the MG and the MGCF.

The circuit network supporter 232 obtains information about a user profile, a service profile, and a service quality class via the IOS A1 interface and feeds the information to the packet network supporter 234. The BSC 214 transmits the user profile, service profile, and service quality class information to the mediation gateway 230 by a call origination request message, CM Service Request Complete L3 info. The user profile is the unique identification information of a circuit network terminal, including MIN (Mobile Identification Number), IMSI (International Mobile Station Identifier), ESN (Electronic Serial Number), priority number, and subscriber URL (Uniform Resource Location). The service profile includes called party number, additional service information, and service options. The service quality class information is required to maintain a service quality at a user-requested level and includes, for example, user-requested resources, that is, bandwidth (bps). The packet network supporter 234 converts the user profile, service profile, and service quality class information to a signal for SIP registration, assignment, and call setup and controls the circuit network terminal to act as a packet network terminal in an IP domain.

FIG. 6 is a view illustrating the main function of the AG 250 according to the present invention. Referring to FIG. 6, the AG 250 additionally has an IP bearer 252 according to the present invention besides a component 254 operating in the same manner as in a conventional AG. The component 254 is connected to the RAN 210 via an R-P interface (Radio-Packet interface) and functions for an IP packet data service.

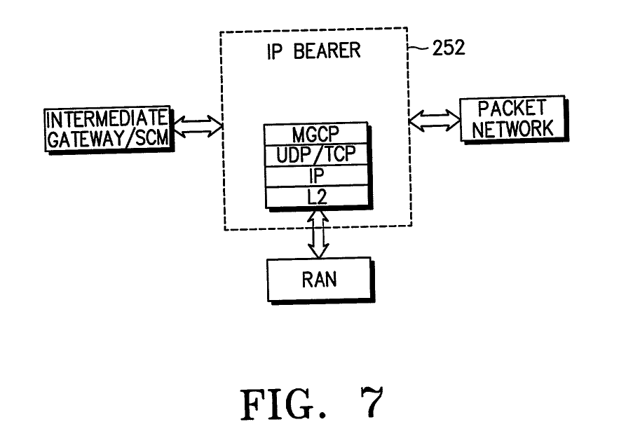

The IP bearer 252 in the AG 250 is connected to the RAN 210 via a bearer interface configured similarly to the R-P interface. The main function of the IP bearer 252 is illustrated in detail in FIG. 7. Referring to FIG. 7, the IP bearer 252 supports H.248 for interfacing with the packet network supporter 234 of the mediation gateway 230 and the SCM 260, and also supports IP and UDP (User Datagram Protocol)/TCP (Transport Control Protocol) to transmit traffic packets after a session is initialized over the packet network. The IP bearer 252 supports signaling for an IP packet voice call together with the packet network supporter 234 and the SCM 260, and additionally RTP (Real-Time Transport Protocol) to act as the end point of an IP voice traffic by terminating an IP packet. Thus the IP traffic is interfaced to a traffic channel in the circuit network.

Hereinbelow, a description will be made of a procedure for providing a packet voice call service to a circuit network terminal with the use of the above-described network devices.

To receive a packet voice call service, the circuit network terminal should register its location in the circuit network and an IP address in the packet network through the mediation gateway.

As for the location registration, when the circuit network terminal transmits a Registration message to the RAN, the RAN transmits a Location Update message to the mediation gateway in response to the Registration message. The mediation gateway checks whether a VLR (Visitor Location Register) has the subscriber information of the circuit network terminal and, if it does, the mediation gateway notifies the RAN that location update is allowed.

Unless the VLR has the subscriber information, the mediation gateway transmits an Authorization Request message to the HLR to acquire the subscriber information. The HLR updates its subscriber database in response to the Authorization Request message and transmits the subscriber information to the mediation gateway so that the database of the VLR can be updated. If the circuit network terminal has already been registered, the HLR transmits a response including the subscriber information to an already registered mediation gateway.

After the location registration is completed, IP registration is initiated.

The mediation gateway, receiving the subscriber information from the HLR, transmits a SIP Registration message including the subscriber URL of the circuit network terminal to the SCM to thereby request IP registration. The subscriber URL is included in the user profile. The mediation gateway represents the URL as an MS-ID that can be expressed as “MSID@serviceproviderdomainname.co.kr” to request the SIP registration. The SCM transmits the Authorization Request message to the AAA server and receives a response from the AAA server. If the SCM receiving the registration request is not a home SCM for the circuit network terminal, the SCM notifies the home SCM that it is not so that the home SCM can perform the SIP registration. The SCM assigns a mobile IP address to the circuit network terminal and stores the assigned mobile IP address in association with the location of the circuit network terminal (i.e., the mediation gateway).

If the SCM notifies the mediation gateway of the completion of the IP address registration, the mediation gateway notifies the RAN of the successful location registration. Then, the RAN transmits a Registration Accepted Order message to the circuit network terminal, notifying that the location registration is successful.

After all these registration procedures are over, the mediation gateway takes charge of the mobility management of the circuit network terminal in the link layer and the SCM takes charge of the mobility management of the circuit network terminal in the IP layer. Thus the circuit network terminal is recognized as a packet network terminal over the packet network.

The circuit network terminal, after the location registration and IP registration, can receive a packet call service upon call origination or call termination.

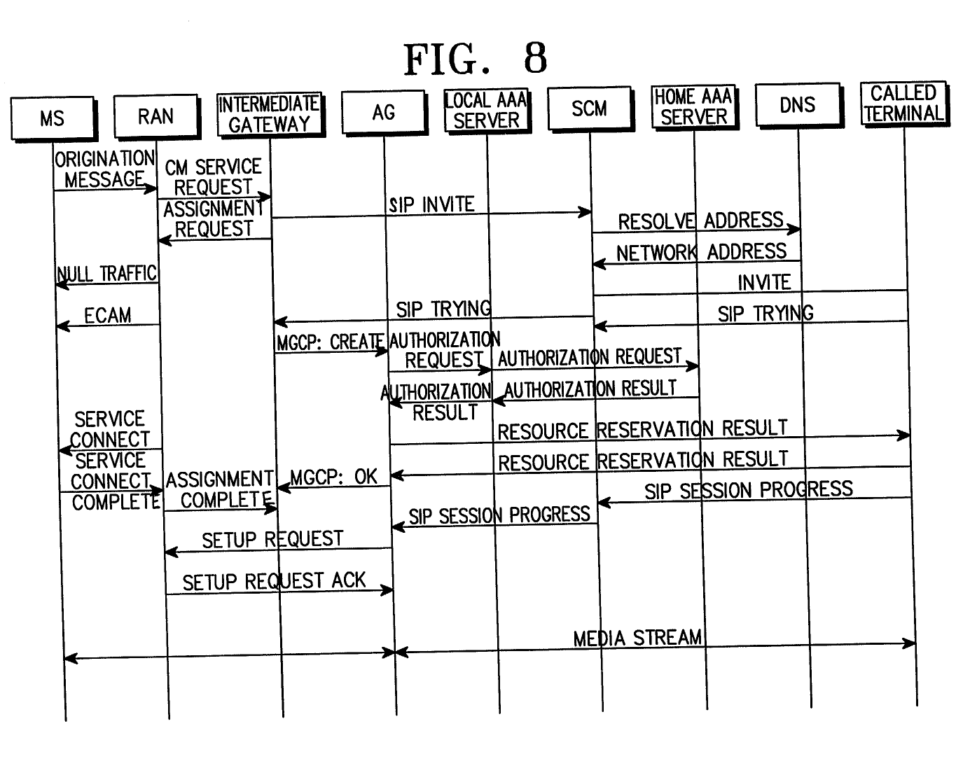

FIG. 8 is a signal flow illustrating a packet voice call origination procedure in the circuit network terminal according to the present invention.

Referring to FIGS. 3 to 8, after the location registration and the IP registration, the circuit network terminal transmits an Origination message to the RAN according to the known radio interface standards (e.g., IS-2000) of the circuit network in order to originate a voice call. The RAN transmits a CM Service Request message to the mediation gateway via the IOS A1 interface. Then the mediation gateway allows assignment of a radio channel by transmitting an Assignment Request message to the RAN, while requesting a session connection by transmitting a SIP Invite message to the SCM.

The SCM requests translation of the IP address of a called terminal to a DNS (Domain Name Server) and receives a response from the DNS. Then the SCM requests a session connection to the called terminal by an Invite message. Upon receipt of a SIP Trying message from the called terminal via the SCM, the mediation gateway requests IP communication for the circuit network terminal to the AG by a Session Create message based on H.248. The Create message includes IP protocol information generated corresponding to the call originating circuit network terminal. To describe more specifically, because the circuit network terminal cannot afford to process the IP for IP communication, the mediation gateway generates the corresponding IP protocol information using the IP address assigned to the circuit network terminal upon the call origination request and, upon receipt of a packet call request from the circuit network terminal, transmits it to the AG. The AG makes the circuit network terminal be recognized as a packet network terminal over the packet network based on the received IP protocol information.

The AG, receiving the Create message from the mediation gateway, performs an authorization procedure for the circuit network terminal and prepares resources for communication between the calling terminal and the called terminal by exchanging messages with the called terminal in a known procedure of IP communication via a local AAA server and a home AAA server. Then the AG notifies the mediation gateway that it is ready for the IP communication by transmitting a response message based on MGCP.

Meanwhile, the SCM requests an IP voice call setup to the AG by an SIP Session Progress message after transmitting the SIP Trying message to the mediation gateway. Then, the AG transmits a Setup Request message for call setup to the RAN and receives a Setup Request Ack message from the RAN in response for the Setup Request message. The RAN is placed in the state where a radio traffic channel is assigned to the circuit network terminal in a known procedure over a wireless network, a service connection is completed, and an Assignment Complete message is transmitted to the mediation gateway. Consequently, the circuit network terminal can conduct a voice call with the called terminal by IP communication via the AG.

During the voice call, the circuit network terminal processes only the protocol of a physical layer, that is, the wireless layer whereas the AG processes the protocols of higher layers, that is, the link layer and the network layer. Thus the circuit network terminal can connect a voice call to the called terminal over the packet network. It is assumed here that the called terminal is a packet network terminal having an IP address, but the above-described procedure is obviously applicable also to the MG even if the called terminal is a typical PSTN terminal.

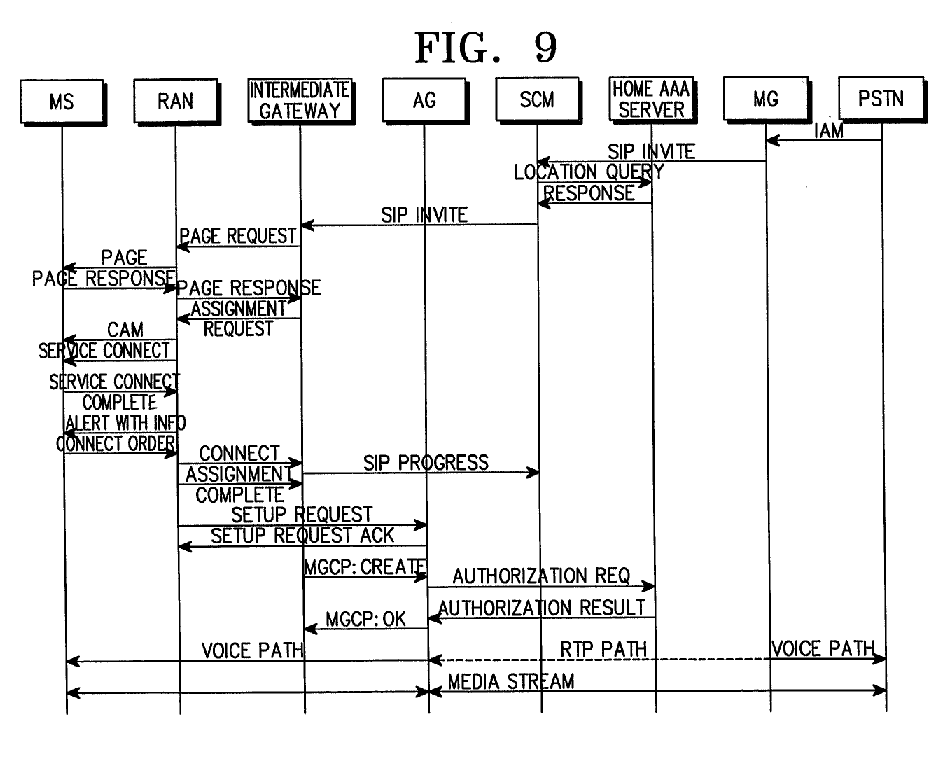

FIG. 9 is a signal flow illustrating a packet voice call termination procedure in the circuit network terminal according to the present invention. The following description is made with the appreciation that the circuit network terminal has completed its location registration and IP registration.

Referring to FIGS. 3 to 7 and FIG. 9, when a PSTN terminal requests a call origination to the PSTN to connect a call to the circuit network terminal, the PSTN transmits an IAM (Initial Address Message) for call origination to the MG. The MG requests a session connection to the called terminal or agent (e.g., MG), that is, the traffic agent of the circuit network terminal by transmitting a SIP Invite message to the SCM. Then, the SCM asks the location of the circuit network terminal over the packet network (that is, the location of the traffic agent) by transmitting a Location Query message to the home AAA server and receives a Response message for the Location Query message. The location of the circuit network terminal on the packet network is the mediation gateway in which the IP address of the circuit network terminal is registered.

The SCM, receiving the Response message, requests a session connection to a corresponding mediation gateway by a SIP Invite message. The mediation gateway transmits a Setup message to the RAN and receives a Page Request message in response for the Setup message. Then, the mediation gateway requests paging to the RAN by a Page message. The mediation gateway pages the circuit network terminal and assigns a radio traffic channel to the circuit network terminal for a voice call by exchanging messages with the RAN and the circuit network terminal via the IOS A1 interface and the IS-2000 radio interface.

If the circuit network answers the page and a Connect message is received from the RAN, the mediation gateway notifies the SCM of the connection by a SIP Progress message. In addition, after assigning a channel and transmitting an Assignment Complete message to the mediation gateway, the RAN transmits a Setup request message to the AG and receives a Setup Request Ack message from the AG in response to the Setup Request message. Then, the mediation gateway transmits IP protocol information generated beforehand for the circuit network terminal to the AG by a Create message based on MGCP. The AG performs an authorization over the packet network using the IP address included in the IP protocol information and transmits an OK message to the mediation gateway.

Upon call termination in the circuit network terminal in the above procedure, the AG connects a voice call path to the circuit network terminal and connects another voice call path to the PSTN by RIP, thereby completing preparation for the voice call. As a result, the circuit network terminal can afford a voice call with the calling terminal by IP communication via the AG. As in the call origination procedure, the circuit network terminal processes only the protocol of a physical layer, that is, the wireless layer whereas the AG processes the protocols of higher layers, that is, the link layer and the network layer during the voice call.

In accordance with the present invention, an IP service can be provided to a conventional legacy terminal with an IS-41 IP gateway network device introduced. Therefore, an additional service such as diverse interactive calls including an individual call and a group call can be provided over an IP network. Furthermore, a single core network architecture according to the present invention exhibits a high utility, reduces network overhead, and facilitates introduction of an all IP network service to a circuit-based network and integration of a synchronous or asynchronous IMT network into an IP network.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A network architecture for providing a packet voice call over a packet-based network to a circuit network terminal supporting wireless communication over a circuit-based network, comprising:
a radio access network (RAN) for providing a call service to the circuit network terminal;
a mediation gateway connected to the RAN via a predetermined signaling interface of the circuit-based network, for performing location registration, authorization, and mobility management to provide a packet voice call service to the circuit network terminal and making the circuit network terminal recognized as a packet network terminal in the packet-based network by performing IP registration for the circuit network terminal; and
an access gateway connected to the mediation gateway via a predetermined signaling interface, for providing predetermined traffic interfacing upon request from the mediation gateway, and connected to the RAN, for transmitting voice traffic from the circuit network terminal to a terminal of a called party via the packet-based network.

2. The network architecture of claim 1, wherein the mediation gateway comprises:
a circuit network supporter for receiving information about a user profile, service profile, and service quality class of the circuit network terminal from the RAN via the predetermined signaling interface; and
a packet network supporter for converting the user profile, service profile, and service quality class information received from the circuit network supporter to a signal for SIP (Session Initiation Protocol) registration, assignment, and call setup processing, and transmitting the converted signal to the packet-based network.

3. The network architecture of claim 2, wherein the circuit network supporter supports IOS A1 interfacing to connect to the RAN and IS-41 interfacing to connect to a home location register (HLR), and manages the mobility of the circuit network terminal.

4. The network architecture of claim 3, wherein the IOS A1 interface is one of an SS7 interface or an ATM interface.

5. The network architecture of claim 2, wherein the packet network supporter performs authorization and billing for the circuit network terminal over the packet-based network.

6. The network architecture of claim 1, wherein the access gateway terminates a traffic packet from the packet-based network and interfaces the terminated traffic packet to the circuit network on a radio traffic channel.

7. The network architecture of claim 1, further comprising a session control manager connected to the mediation gateway via a predetermined signaling interface, for controlling a session connection for the packet voice call service of the circuit network terminal upon request from the mediation gateway.

8. A registration method for providing a packet voice call service over a packet-based network to a circuit network terminal supporting wireless communication over a circuit-based network, comprising the steps of:
receiving a registration request from the circuit network terminal through a radio access network (RAN) via a circuit-based network interface;
updating subscriber information of the circuit network terminal and registering a location of the circuit network terminal in response to the registration request;
requesting IP registration of the circuit network terminal to the packet-based network; and
transmitting a registration result to the circuit network terminal via the RAN upon receipt of the registration result from the packet-based network.

9. A call origination method for providing a packet voice call service over a packet-based network to a circuit network terminal supporting wireless communication over a circuit-based network, comprising the steps of:
receiving a packet voice call origination request at a mediation gateway from the circuit network terminal through a radio access network (RAN) via a circuit-based network interface;
transmitting IP protocol information generated for the circuit network terminal from the mediation gateway to an access gateway; and
connecting the circuit network terminal to the packet-based network using the IP protocol information and providing the packet voice call service to the circuit network terminal by the access gateway.

10. A call termination method for providing a packet voice call service over a packet-based network to a circuit network terminal supporting wireless communication over a circuit-based network, comprising the steps of:
requesting a call termination at the circuit network terminal to a mediation gateway by the packet-based network;
paging the circuit network terminal through a radio access network (RAN) via a circuit-based network interface by the mediation gateway;
transmitting IP protocol information generated for the circuit network terminal from the mediation gateway to an access gateway upon receipt of a response for the paging; and
connecting the circuit network terminal to the packet-based network using the IP protocol information and providing the packet voice call service to the circuit network terminal by the access gateway.
